(19) United States
(12) Patent Application Publication
(10) Pub. No.: US 2024/0198243 A1
(43) Pub. Date: Jun. 20, 2024

(54) SYSTEM AND METHOD FOR CONTROLLING OPERATION OF A RIDE SYSTEM BASED ON GESTURES

(71) Applicant: UNIVERSAL CITY STUDIOS LLC, Universal City, CA (US)

(72) Inventors: Gregory RELL, Orlando, FL (US); Dennis GEBKEN, Orlando, FL (US)

(21) Appl. No.: 18/082,472

(22) Filed: Dec. 15, 2022

(51) Int. Cl. A63G 31/02; G05B 19/048; G06V 40/20

(52) U.S. Cl. CPC A63G 31/02; G05B 19/048; G06V 40/20; G05B 2219/23021

(57) ABSTRACT

A ride control system for controlling operation of an amusement park ride having a ride station area wherein patrons embark and disembark from a ride vehicle under supervision of one or more ride operators, includes a vision system and a ride control processor. The vision system capture images of one or more of the one or more ride operators at one or more locations within the ride station area. The ride control processor receives one or more images from the vision system and includes a machine-learned module configured to recognize one or more valid gestures within the one or more images, where a valid gesture corresponds to a gesture from at least one of the one or more ride operators, and program logic configured to process the one or more valid gestures within the one or more images to enable a ride operation.

### TECHNICAL FIELD

The technology discussed below relates generally to amusement park ride systems, and more particularly, to systems and methods for controlling the operation of a ride system based on gestures.

### BACKGROUND

Operator control consoles are the primary point of operation for amusement park ride systems. These consoles contain console interfaces (e.g., buttons, switches, sliders, dials) that control the operation of the ride. For example, the consoles include console interfaces that enable a stopping of the system, and a running or dispatching of the system. Consoles are replicated or placed in a ride station area where an operator is permanently positioned to active console interfaces that control the ride. This causes overstaffing and inefficiencies by requiring additional employees to perform other operational tasks, e.g., ensuring riders are properly seated and restrained in a ride vehicle, while still maintaining an operator at the console. Further to this point there are always debates about having sufficient consoles, or having to supplement operators with wireless hand packs with stopping capabilities. This causes a lot of additional cost and reliability issues.

### SUMMARY

Aspects of the present disclosure relate to a ride control system for controlling operation of an amusement park ride having a ride station area wherein patrons embark and disembark from a ride vehicle under supervision of one or more ride operators. The ride control system includes a vision system and a ride control processor coupled to receive one or more images from the vision system. The vision system is configured to capture one or more images of at least one of the one or more of ride operators at one or more locations within the ride station area. The ride control processor includes a machine-learned module configured to recognize one or more valid gestures within the one or more images, where a valid gesture corresponds to a gesture from at least one of the one or more ride operators. The ride control processor also includes program logic configured to process the one or more valid gestures within the one or more images to enable a ride operation.

Aspects of the present disclosure also relate to a method of controlling operation of an amusement park ride having a ride station area wherein patrons embark and disembark from a ride vehicle under supervision of one or more ride operators. The method includes capturing one or more images of at least one of the one or more ride operators at one or more locations within the ride station area; recognizing one or more valid gestures within the one or more images, where a valid gesture corresponds to a gesture from at least one of the one or more of ride operators; and processing the one or more valid gestures within the one or more images to enable a ride operation.

The present disclosure also relates to a ride control processor that includes a machine-learned module and program logic. The machine-learned module is configured to recognize one or more valid gestures within one or more images. A valid gesture corresponds to a gesture from at least one of one or more ride operators within a ride station area. The machine-learned module includes a first model that is trained to identify within images, a gesture corresponding to a gesture within a set of programmed gestures, and a second model that is trained to determine the gesture is made by at least one of the one or more ride operators. The program logic is configured to process the one or more valid gestures within the one or more images to enable a ride operation.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a schematic diagram of a conventional ride station area of an amusement park ride.

FIG. 2 is a schematic diagram of a ride station area of an amusement park ride having a ride control system configured to control ride operations based on valid gestures from ride operators.

FIG. 3 is a block diagram of the ride control system of FIG. 2 including a machine-learned module configured to recognize gestures and ride operators and program logic configured to process valid gestures to control ride operations.

FIG. 4A-4E are schematic drawings of gestures recognizable by the machine-learned module.

FIG. 5 is a diagram of logic flow executed by the ride control system of FIG. 3 to initiate a dispatch ride operation based on valid gestures from a number of ride operators.

FIG. 6 is a diagram of logic flow executed by the ride control system of FIG. 3 to initiate an emergency stop based on a valid gesture from a single ride operator.

FIG. 7 is a flowchart of a method of controlling operation of an amusement park implemented with the ride control system of FIG. 3.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. While aspects and embodiments are described in this application by illustration to some examples, those skilled in the art will understand that additional implementations and use cases may come about in many different arrangements and scenarios. Innovations described herein may be implemented across many differing platform types, devices, and systems.

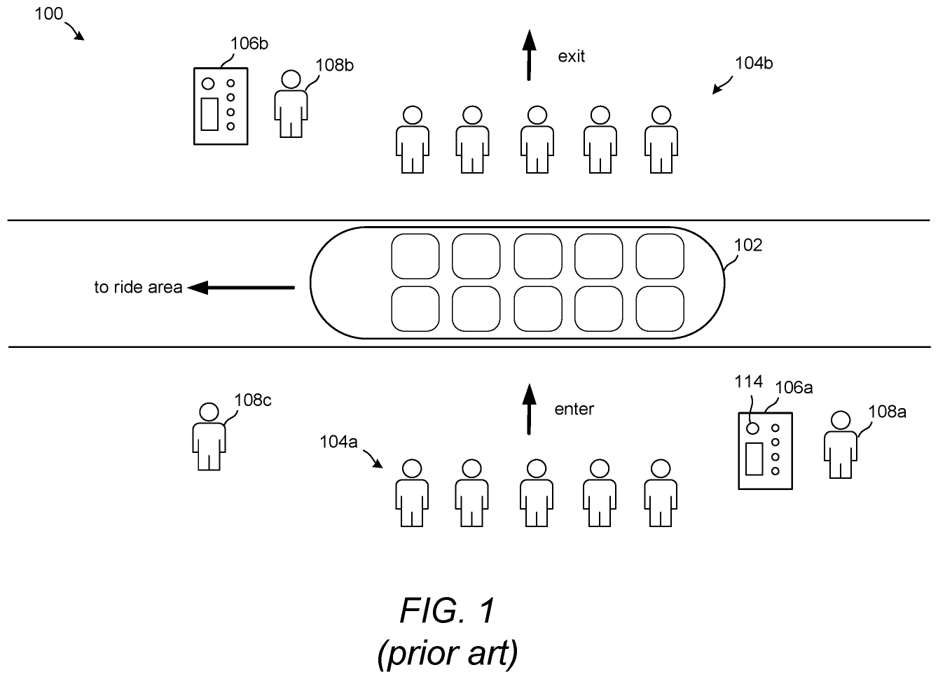

FIG. 1 is a schematic illustration of a conventional ride station area 100 of an amusement park ride. The ride station area 100 is the area where a ride vehicle 102 is unloaded and loaded with patrons before being sent out into the ride area. In the configuration shown in FIG. 1, patrons 104a enter (or embark) the ride vehicle 102 at the same location where patrons 104b exit (or disembark) the ride vehicle. In other ride station configurations (not shown), patrons exit the ride vehicle in one area, and the ride vehicle is advanced to another area where patrons enter the ride vehicle. In some ride station configurations, ride vehicles 102 come to a complete stop before being unloaded and loaded with patrons. In other configurations, ride vehicles continuously move through the ride station area at a slow enough speed that allows for unloading and loading of patrons.

In either configuration, operator control consoles 106a, 106b within the ride station area 100 are used by ride operators 108a, 108b, 108c to do a variety of ride functions. The operator control console 106a, 106b are usually fixed in place and at least one ride operator 108a, 108b is at each operator control console 106a, 106b. Most operations involving the start of motion of a ride vehicle 102 out of the ride station area 100 and into the ride area require a minimum of two ride operators 108a, 108b to press and hold a dispatch console interface 114 on their respective operator control console 106a, 106b. To this end, the ride operators within the ride station area are in line of sight of each other and a ride operation is initiated when each ride operator at an operator control console provides a visual signal to the other operator, and observes the same visual signal from the other operator.

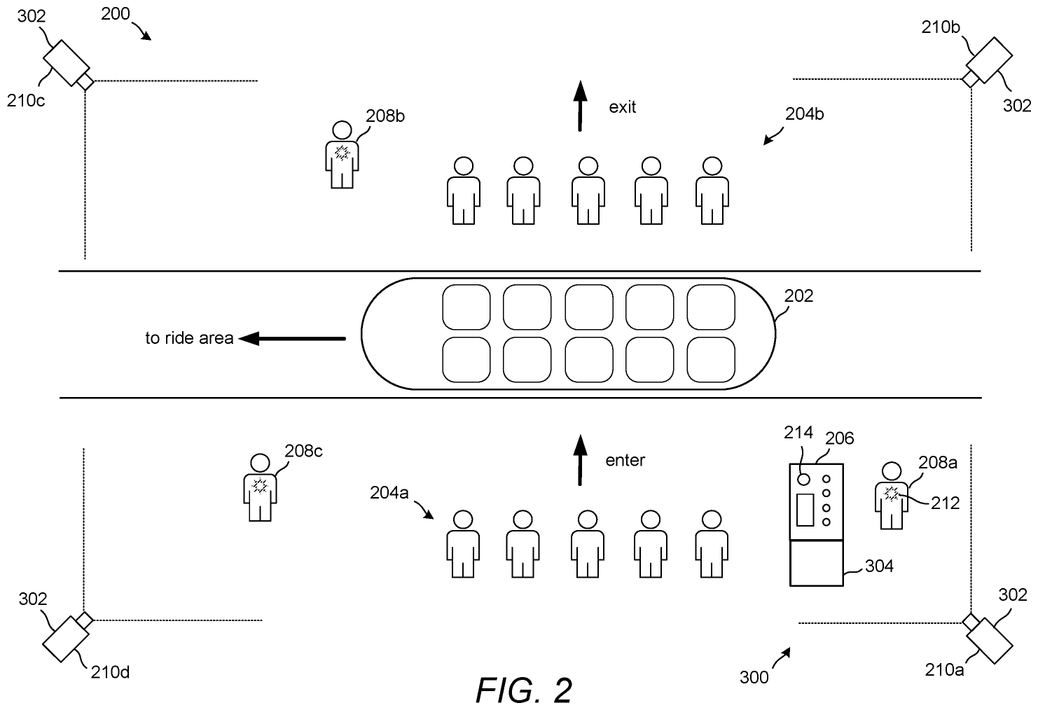

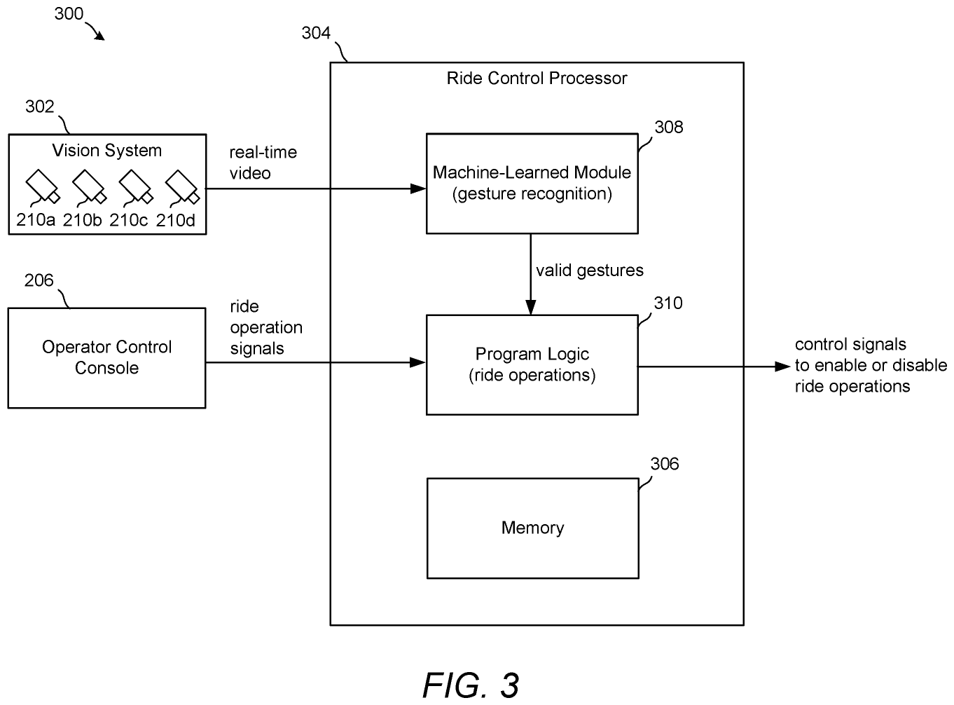

FIG. 2 is a schematic illustration of a ride station area 200 of an amusement park ride having a ride control system 300 in accordance with embodiments disclosed herein. FIG. 3 is a block diagram of a ride control system 300 in accordance with embodiments disclosed herein. In the configuration shown in FIG. 2, patrons 204a enter (or embark) the ride vehicle 202 at the same location where patrons 204b exit (or disembark) the ride vehicle. A single operator control console 206 within the ride station area 200 is operated by a single ride operator 108a to do a variety of ride functions. Thus, in this ride station area 200, a single operator control console 206 exists and requires only a single console interface 214 press by one operator 108a instead of multiple console interface presses are multiple operator control consoles, as in the conventional ride station area of FIG. 1. In some embodiments, the single operator control console 206 is fixed in place. In some embodiments, the single operator control console 206 is a wireless, handheld roaming console that allows an operator 108a to move around within the ride station area 200.

With reference to FIGS. 2 and 3, the ride control system 300 includes a vision system 302 and a ride control processor 304. The vision system 302 is configured to capture video images of the ride operators 208a, 208b, 208c at different locations within the ride station area 200, and to feed the video images to the ride control processor 304 in real time. The vision system 302 includes as many cameras as needed to capture a full view of the ride station area 200. In the ride control system 300 of FIGS. 2 and 3, the vision system 302 includes four video cameras 210a, 210b, 210c, 210d. The ride control processor 304 may be coupled with or integrated in the operator control console 206 as shown in FIG. 2 or it may be a separate component remote from the operator control console 206 and in wired or wireless communication with the operator control console 206.

The ride control processor 304 is coupled to the vision system 302 to receive images captured by the vision system 302. The ride control processor 304 is also coupled to the operator control console 206 to receive ride operation signals resulting from manual activation (e.g., mechanical activation, electrical activation, electromechanical activation, hydraulic activation, pneumatic activation) by a ride operator. The ride control processor 304 includes a machine-learned module 308 and program logic 310. The machine-learned module 308 is configured to recognized one or more valid gestures within one or more images captured by the vision system 302. As used herein, a valid gesture corresponds to a gesture made by at least one of one or more of ride operators, as opposed to a gesture made by someone other than a ride operator, such as a patron 204a, 204b.

The program logic 310 is configured to process the one or more valid gestures within the images to automatically enable or disable ride operations. In some configurations, the program logic 310 is configured to process the one or more valid gestures within the one or more images together with console interface 214 activations originating from the operator control console 206 to enable or disable ride operations.

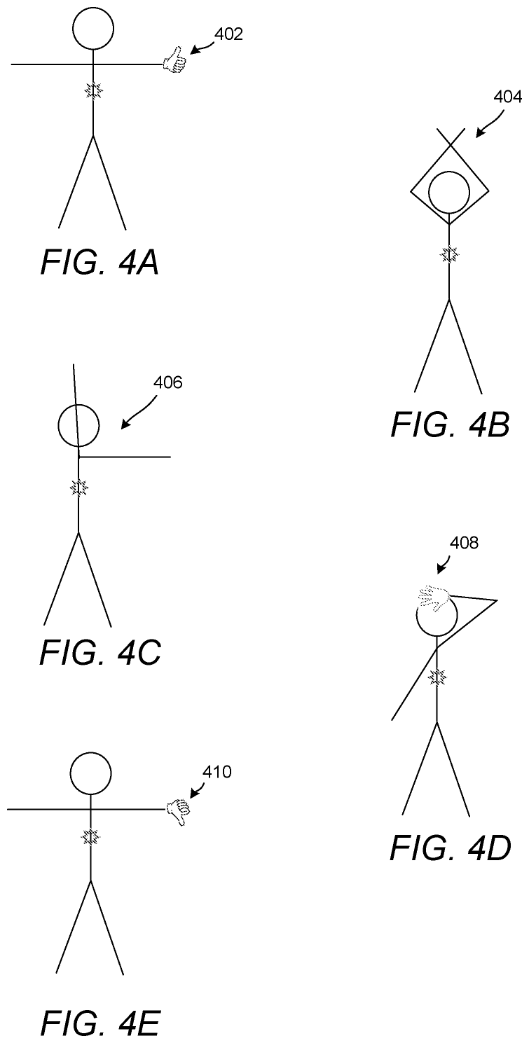

The machine-learned module 308 comprises a custom gesture-based recognition software. In one configuration, the machine-learned module 308 comprises one or more convolutional neural networks (CNN) models. A first CNN model is trained to recognize a set of ride-control gestures that a ride operator may make using their hands or arms. For example, with reference to FIGS. 4A-4E, the first CNN model may be trained to recognize a set of ride-control gestures including: a thumb up 402 on single hand (FIG. 4A), hands crossed above head making an X 404 (FIG. 4B), arms in the shape of an L 406 (see FIG. 4C), single hand placed on head 408 (FIG. 4D), and thumb down 410 on one or more hands (FIG. 4E).

A second CNN model is trained to recognize a feature associated with a ride operator. For example, with reference to FIG. 2, the second CNN model may be trained to recognize a feature 212 (e.g., emblem (e.g., retroreflective emblem), pattern, patch, or symbol (e.g., barcode, quick response (QR) code)) as part of a uniform that a ride operator would be wearing. For example, a retroreflective emblem may be placed in one or more locations on the operator's uniform such that the retroreflective emblem may be always detected by the vision system 302. The emblem could be recognized by either 1) being a recognizable shape such as a circle, square, triangle, etc. or 2) having a minimum detectable surface area, e.g., 100 cm², of retroreflective surface detected. Additional logic may be incorporated, such as to only consider retroreflective emblems on shirts that are a certain color, e.g., red, blue, orange, etc. The second CNN model may be trained to recognize ride operators based on facial recognition. In either case, the second CNN model prevents the ride control processor 304 from processing gestures made by people in the ride station area 200 that are not ride operator. In combination, the first CNN model and the second CNN model provide a machine-learned module 308 that recognizes valid gestures, i.e., a ride-control gesture that is being made by a ride operator.

In other configurations, the vision system 302 may include an optical recognition camera configured to recognize ride operators based on a pattern of light generated by an identifier worn by the ride operator. An example of technology that enable such recognition is disclosed in U.S. Patent Application Publication No. 2021/0342616, which is herein incorporated by reference. In this configuration, instead of having a second CNN model, the ride control processor 304 includes a filter function that extracts images of gestures associated with recognized ride operators from the real-time video image feed of the vision system, 302 and provides the extracted images to the first CNN model of the machine-learned module 308.

In either configuration, the machine-learned module 308 provides signals indicative of each valid gesture to the program logic 310. The program logic 310 processes the valid gestures and provides control signals that initiate certain ride operations when certain logic conditions are satisfied. Examples of two different logic flows of the program logic 310 for two different gestures and ride operations follows:

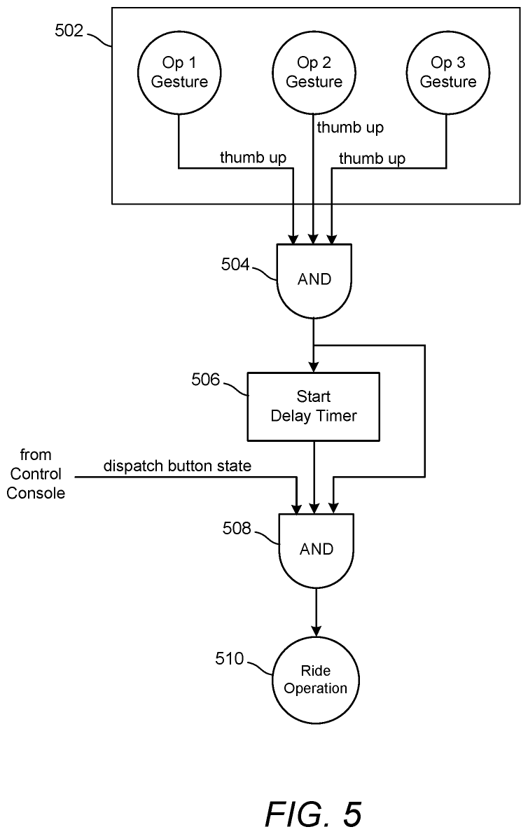

FIG. 5 is a flow diagram of an example operation of the machine-learned module 308 and program logic 310 that initiates dispatch of a ride.

At block 502, the machine-learned module 308 recognizes one or more valid gestures and provides a signal indicative of each valid gesture to the program logic 310. In this example, a valid gesture in the form of a thumb up 402 is recognized from three ride operators.

At block 504, an AND operator of the program logic 310 determines when a pre-defined number of valid gestures corresponding to a dispatch operation have been recognized by the machine-learned module 308. In the example of FIG. 5, the pre-defined number of valid gestures is three. Accordingly, when at least three valid dispatch gestures are input to the AND operator at block 504 the AND operator outputs a logic state indicative of that condition, in which case the logic flow continues. When less than three valid dispatch gestures are input to the AND operator at block 504 the AND operator outputs a logic state indicative of that condition, in which case the logic flow ends, and the ride is not dispatched.

For certain ride operations, including ride dispatch, the program logic 310 includes a duration criteria. For example, once a certain gesture is originally recognized by the machine-learned module 308, the gesture may be required to be continuously maintained or held by the ride operator for a number of seconds by the program logic 310. To this end, at block 506, the program logic 310 starts a delay timer when the AND operation at block 504 of the program logic 310 determines that the pre-defined number of valid dispatch gestures has been recognized by the machine-learned module 308.

At block 508, a logic state corresponding to the state of the timer at block 506 is provided to an AND operator. The logic state of the timer indicates either the timer is running, or the timer has elapsed. The logic state of the AND operator at block 504 is also provided to the AND operator at block 508. The logic state of a dispatch console interface 214 on the operator control console 206 is also provided to the AND operator at block 508. This logic state indicates whether the dispatch console interface 214 at the operator control console 206 is in a released state or a pressed state. If the logic states input to the AND operator at block 508 indicate that the dispatch console interface 214 has been activated at the operator control console 206, the timer has elapsed, and all operators are still holding their respective dispatch gesture, the logic flows to block 510.

At block 510, the program logic 310 outputs a control signal to the ride control system 300 that dispatches the ride vehicle. This ends the dispatch logic operation of the ride control system 300. At this time, the ride operators can release their dispatch gesture without affecting operation of the ride.

Returning to the AND operator at block 508, when the logic states input to the AND operator indicate any one of: 1) the dispatch console interface 214 has not been activated at the operator control console 206, 2) the timer is still running, or 3) all of the pre-defined number of ride operators are not still holding their respective valid dispatch gesture, then the logic flow ends, and the ride is not dispatched.

The delay timer at block 506 is a safety feature and prevents any dispatch activation that may be initiated at the operator control console 206 ahead of the expiration of the timer from affecting operation of the ride. The delay timer also ensures that nothing has occurred in the ride station area that would have caused a ride operator to release their dispatch gesture. In one example, the delay time for dispatch is two seconds.

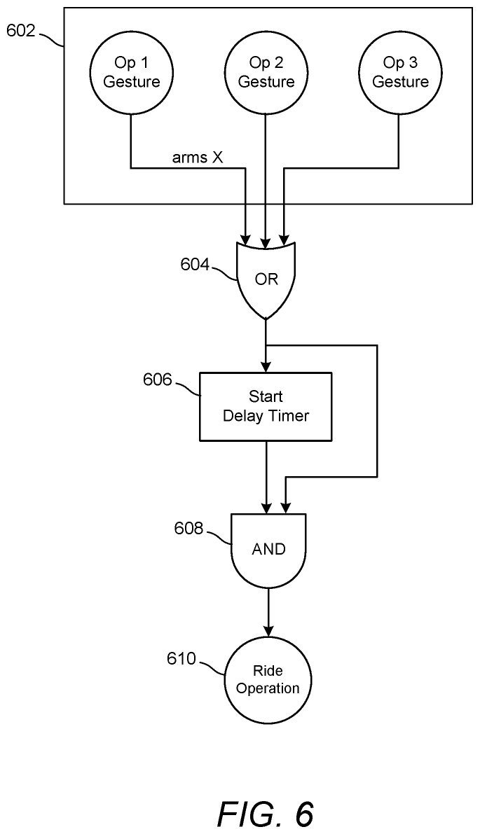

FIG. 6 is a flow diagram of an example operation of the machine-learned module 308 and program logic 310 that initiates an emergency stop of a ride vehicle.

At block 602, the machine-learned module 308 recognizes at least one valid gesture and provides a signal indicative of that valid gesture to the program logic 310. In this example, a valid emergency stop gesture in the form of forearms crossed above head making an X 404 is recognized from one of three ride operators.

At block 604, an OR operator of the program logic 310 determines when at least one valid emergency stop gesture has been recognized by the machine-learned module 308. If no valid emergency stop gesture is input to the OR operator, the logic flow ends, and the ride vehicle is not stopped.

For an emergency stop, the program logic 310 includes a duration criteria. For example, once a valid emergency stop gesture is originally recognized by the machine-learned module 308, the valid emergency stop gesture may be required to be continuously maintained or held by the ride operator for a number of seconds by the program logic 310. To this end, at block 606, the program logic 310 starts a delay timer when the OR operation of the program logic 310 determines that at least one valid emergency stop gesture has been recognized by the machine-learned module 308.

At block 608, a logic state corresponding to the state of the timer at block 606 is provided to an AND operator. The logic state of the timer indicates either the timer is running or the timer has elapsed. The logic state of the OR operator at block 604 is also provided to the AND operator at block 608. If the logic states input to the AND operator at block 608 indicate that the timer has elapsed, and the ride operator is still holding the valid emergency stop gesture, the logic flows to block 610.

At block 610, the program logic 310 outputs a control signal to the ride control system 300 that stops the ride vehicle. This ends the emergency stop logic operation of the ride control system 300. At this time, the ride operator can release their emergency stop gesture without affecting operation of the ride vehicle.

Returning to the AND operator at block 608, when the logic states input to the AND operator indicate either of: 1) the timer is still running or 2) the ride operator is not still holding the emergency stop gesture, then the logic flow ends, and the ride vehicle is not stopped.

The delay timer is a safety feature and prevents a sudden, unintended valid emergency stop gesture from affecting operation of the ride vehicle. In one example, the delay time for emergency stop is 0.5 seconds.

Other ride operations may be controlled using logic similar to FIG. 6. For example, the same logic may be used to unlock ride restraints, to close pedestrian gates, or to initiate a station stop. Each of these operations is implemented based on a valid gesture from a single ride operator and with various time delays. Table 1 below summarizes these ride operations and the dispatch and emergency stop ride operations described in detail above with reference to FIGS. 5 and 6.

TABLE 1

| | | | Required |
|---|---|---|---|
| Gesture | Ride Action | Description | Operators |
| Thumb up on | DISPATCH | Detection of a pre- | Pre-defined |
| single hand | | defined number of | number |
| (see FIG. 4A) | | valid “dispatch” | |
| | | gestures for 2 | |
| | | seconds. This | |
| | | generates a | |
| | | permissive logic | |
| | | signal in the | |
| | | program logic 310 | |
| | | which allows a | |
| | | single dispatch | |
| | | console interface | |
| | | on the operator | |
| | | control console to | |
| | | generate a | |
| | | command signal to | |
| | | the ride control | |
| | | system 300 to | |
| | | initiate dispatch. | |
| Hands crossed | ESTOP | Detection of at | At least one |
| above head | | least one valid | |
| making an ‘X’ | | “emergency stop” | |
| (see FIG. 4B) | | gesture from any | |
| | | one ride operator | |
| | | for 0.5 seconds. | |
| | | This generates a | |
| | | command signal to | |
| | | the ride control | |
| | | system 300 to stop | |
| | | all equipment in | |
| | | the building the | |
| | | houses the attraction | |
| Arms in the | UNLOCK | Detection of at | At least one |
| shape of an L | RESTRAINTS | least one valid | |
| (see FIG. 4C) | | “unlock restraints” | |
| | | gesture from any | |
| | | one ride operator | |
| | | for 2 seconds. This | |
| | | generates a | |
| | | command signal to | |
| | | the ride control | |
| | | system 300 to | |
| | | release the | |
| | | restraints at the | |
| | | currently parked | |
| | | ride vehicle | |
| Single hand | CLOSE | Detection of at | At least one |
| placed on head | PEDESTRIAN | least one valid | |
| (see FIG. 4D) | GATES | “close pedestrian | |
| | | gates” gesture | |
| | | from any one ride | |
| | | operator for 2 | |
| | | seconds. This | |
| | | generates a | |
| | | command signal to | |
| | | the ride control | |
| | | system 300 to close | |
| | | the pedestrian gates | |
| | | in the station area | |
| Thumb down | STATION | Detection of at | At least one |
| on one or | STOP | least one valid | |
| more hands | | “station stop” | |
| (see FIG. 4E) | | gesture from any | |
| | | one ride operator | |
| | | for 0.5 seconds. | |
| | | This generates a | |
| | | command signal to | |
| | | the ride control | |
| | | system 300 to stop | |
| | | all equipment in | |
| | | the ride station area | |

Considering the flow diagram of FIG. 6 further, in some instances different valid gestures intended to initiate different ride operations may be simultaneously recognized by the machine-learned module 308 and provided to the program logic 310. In such cases, the program logic 310 is configured to process each valid gesture in accordance with known existing logic to determine if the ride operation associated with each of the valid gestures is a “legal” operation. In other words, if the program logic 310 determines there is nothing preventing a ride operation from happening, the program logic will output a control signal to initiate the operation.

In some cases, the ride operation associated with each of the valid gestures may be initiated simultaneously, in which case the program logic outputs a corresponding control signal for each operation. In cases where the program logic 310 determines that the ride operations cannot be initiated at the same time, the program logic initiates the ride operations in accordance with a programmed execution order. In some cases, one of the operations may be initiated first, followed by the other operation. In some cases, one of the operations may be initiated while the other is ignored.

Regarding training of the CNNs of the machine-learned module 308, the first CNN model may be trained using known techniques to recognize a set of programmed gestures 402, 404, 406, 408, 410 based on a dataset of images of the programmed gestures captured at various locations within the ride station area 200. The images may correspond to individual frames of a video captured by a video camera while a ride operator is making a gesture. The video may be captured in the ride station area 200 using the vision system 302. The training of the first CNN model may be in an unsupervised fashion, or the training of the first CNN model may be in a supervised fashion, where the images in the dataset are manually labeled with a gesture and applied to a CNN. In an example of supervised training, a large sample size of images, e.g., 10,000 images, of multiple people performing the various gestures are labelled. For example, people standing with their arms crossed over their head are labelled as ‘arms crossed’ and used to train a CNN model output to register ‘arms crossed’ by feeding in those images into the CNN, seeing what the output of the CNN is, comparing the CNN output with the correct output, and adjusting the weights of the CNN using back propagation as needed to obtain an accurate CNN output.

The second CNN model may be trained using known techniques to recognize and determine that a gesture is made by a ride operator based on a labeled dataset of images of a feature associated with the ride operators. The feature 212 may be, for example, a pattern, an emblem (e.g., retroreflective emblem), symbol (e.g., barcode, QR code), or a patch on a uniform that would be worn by a ride operator. The images may correspond to individual frames of a video captured by a video camera while a ride operator is in the ride station area 200. The video may be captured in the ride station area 200 using the vision system 302. The training of the second CNN model may be in an unsupervised fashion, or the training of the second CNN may be in a supervised fashion, where the images in the dataset are manually labeled with the feature 212 and applied to a CNN. In an example of supervised training, a large sample size of images, e.g., 10,000 images, that include a feature are labelled. For example, people wearing a uniform with a particular feature in the form of an emblem are labelled as ‘emblem’ and used to train a CNN model output to register ‘emblem’ by feeding in those images into the CNN, seeing what the output of the CNN is, comparing the CNN output with the correct output, and adjusting the weights of the CNN using back propagation as needed to obtain an accurate CNN output.

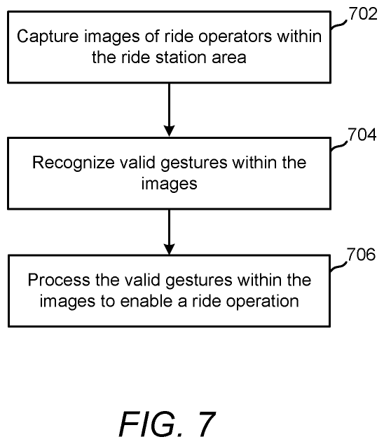

FIG. 7 is a flowchart of a method of controlling operation of an amusement park ride having a ride station area wherein patrons embark and disembark from a ride vehicle under supervision of one or more ride operators. The method may be performed by the ride control system 300 of FIGS. 2 and 3.

At block 702, and with additional reference to FIGS. 2 and 3, one or more images of the one or more ride operators 208a, 208b, 208c are captured at one or more locations within the ride station area 200 by a vision system 302. The vision system 302 includes a number of video cameras 210a, 210b, 201c, 210d positioned to provide fields of view that encompass the ride station area 200. The video cameras 210a, 210b, 201c, 210d provide a real-time video feed of the ride operators 208a, 208b, 208c.

At block 704, and with additional reference to FIGS. 3 and 4, one or more valid gestures are recognized within the one or more images. To this end, the one or more images captured by the vision system 302 are applied to a machine-learned module 308 having a first model that is trained to identify a gesture 402, 404, 406, 408, 410 corresponding to a gesture within a set of programmed gestures. Any number of different gestures may be included in the set of programmed gestures. An example set of programmed gestures is shown in FIGS. 4A-4E.

Continuing at block 704, the one or more images captured by the vision system 302 are also applied to a second model of the machine-learned module 308 that is trained to determine when a gesture 402, 404, 406, 408, 410 identified by the first model is made by one of the one or more ride operators. To this end, the second model is trained to recognize features 212 associated with ride operators. The feature 212 may be, for example, a pattern, an emblem (e.g., retroreflective emblem), symbol (e.g., barcode, QR code), or a patch on a uniform that would be worn by a ride operator.

At block 706, and with additional reference to FIGS. 3, 5, and 6, the valid gestures recognized within the one or more images are processed by program logic 310 to enable a ride operation.

With reference to FIG. 5, in some embodiments, processing the valid gestures within the images to enable a ride operation includes enabling a ride operation from a first set of ride operations when the images include a same valid gesture from at least two of the ride operators. The first set of ride operations may include, for example, ride dispatch. In some embodiments, in addition to requiring the same valid gesture from at least two of the ride operators, the processing by the program logic 310 requires that the same valid gesture is continuously present within the images for a threshold duration. The threshold duration is programmable and may be, for example, two seconds. In some embodiments, in addition to requiring the same valid gesture from at least two of the ride operators for a specified duration, the processing by the program logic 310 requires the receiving of a corresponding operation signal from an operator control console.

With reference to FIG. 6, in some embodiments, processing the valid gestures within the images to enable a ride operation includes enabling a ride operation from a second set of ride operations when the images include a valid gesture from at least one of the ride operators. The second set of ride operations may include, for example, emergency stop, station stop, unlock restraints, close pedestrian gate, etc. In some embodiments, in addition to requiring a valid gesture from one of the ride operators, the processing by the program logic 310 requires that the valid gesture is present within the images for a threshold duration. The threshold duration is programmable and may be, for example, 0.5. seconds, or two seconds.

With reference to FIG. 3, as disclosed herein operations of an amusement park ride may be controlled utilizing a ride control processor 304. The ride control processor 304 may be any device employing a processor, such as an application-specific processor. The ride control processor 304 may also include a memory 306 storing instructions executable by the machine-learned module 308 and the program logic 310 to perform the methods and ride control operations described. The machine-learned module 308 and the program logic 310 may include one or more processing devices, and the memory 306 may include one or more tangible, non-transitory, machine-readable media. By way of example, such machine-readable media can include RAM, ROM, EPROM, EEPROM, optical disk storage, magnetic disk storage or other magnetic storage devices, or any other medium that can be used to carry or store desired program code in the form of machine-executable instructions or data structures and that can be accessed by the machine-learned module 308 and the program logic 310 or by any general purpose or special purpose computer or other machine with a processor.

Thus, disclosed herein is a ride control system 300 for controlling operation of an amusement park ride under supervision of one or more ride operators. The ride control system 300 includes a vision system 302 and a ride control processor 304 coupled to receive images from the vision system 302. The vision system 302 is configured to capture images of one or more of the one or more ride operators at one or more locations within the ride station area. The ride control processor 304 includes a machine-learned module 308 configured to recognize one or more valid gestures within the one or more images. The ride control processor 304 also includes program logic 310 configured to process the one or more valid gestures within the one or more images to enable a ride operation.

The ride control system 300 disclosed herein is advantageous over current systems in that it enables control of ride operations from a single operator control console without requiring all ride operators to be in line of sight of the ride operator at the operator control console.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For instance, a first object may be coupled to a second object even though the first object is never directly physically in contact with the second object.

One or more of the components, steps, features and/or functions illustrated in FIGS. 1-7 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A ride control system for controlling operation of an amusement park ride having a ride station area under supervision of one or more ride operators, the ride control system comprising:
a vision system configured to capture images of one or more of the one or more ride operators at one or more of locations within the ride station area; and
a ride control processor coupled to receive one or more images from the vision system, the ride control processor comprising:
a machine-learned module configured to recognize one or more valid gestures within the one or more images, where a valid gesture corresponds to a gesture from at least one of the one or more ride operators, and
program logic configured to process the one or more valid gestures within the images to enable a ride operation.

2. The ride control system of claim 1, wherein the machine-learned module is configured to recognize one or more valid gestures within the one or more images by being trained to:
identify a gesture within the one or more images corresponding to a gesture within a set of programmed gestures; and
determine the identified gesture is made by at least one of the one or more ride operators.

3. The ride control system of claim 2, wherein the machine-learned module is trained to identify a gesture within the one or more images corresponding to a gesture within the set of programmed gestures based on a labeled dataset of images of programmed gestures captured at one or more locations within the ride station area.

4. The ride control system of claim 3, wherein images of programmed gestures within the labeled dataset are captured by the vision system.

5. The ride control system of claim 2, wherein the machine-learned module is trained to determine the identified gesture is made by at least one of the one or more ride operators based on a labeled dataset of images of a feature associated with the one or more ride operators.

6. The ride control system of claim 1, wherein the program logic is configured to enable a ride operation when:
the one or more valid gestures within the one or more images comprise a plurality of a same valid gesture from at least two of the one or more ride operators.

7. The ride control system of claim 1, wherein the program logic is configured to enable a ride operation when:
the one or more valid gestures within the one or more images comprise a plurality of a same valid gesture from at least two of the one or more ride operators, and
each of the plurality of the same valid gesture is present within the one or more images for a threshold duration.

8. The ride control system of claim 1, wherein the ride control processor is coupled to an operator control console, and the program logic is configured to enable a ride operation when:
the one or more valid gestures within the one or more images comprise a plurality of a same valid gesture from at least two of the one or more ride operators,
each of the plurality of the same valid gesture is present within the one or more images for a threshold duration, and
a corresponding operation signal is received from the operator control console.

9. The ride control system of claim 1, wherein the program logic is configured to enable a ride operation when:
the one or more valid gestures within the one or more images comprise a single valid gesture from at least one of the one or more ride operators.

10. The ride control system of claim 1, wherein the program logic is configured to enable a ride operation when:
the one or more valid gestures within the images comprise a single valid gesture from at least one of the one or more ride operators, and
the single valid gesture is present within the images for a threshold duration.

11. A method of controlling operation of an amusement park ride having a ride station area under supervision of one or more ride operators, the method comprising:
capturing one or more images of one or more of the one or more ride operators at one or more locations within the ride station area;
recognizing one or more valid gestures within the one or more images, where a valid gesture corresponds to a gesture from at least one of the one or more ride operators; and
processing the one or more valid gestures within the one or more images to enable a ride operation.

12. The method of claim 11, wherein recognizing one or more valid gestures within the one or more images comprises:
applying the one or more images to a machine-learned module trained to identify a gesture corresponding to a gesture within a set of programmed gestures; and
applying the one or more images to a machine-learned module trained to determine the identified gesture is made by one of the one or more ride operators.

13. The method of claim 11, wherein processing the one or more valid gestures within the one or more images to enable a ride operation comprises:
enabling the ride operation when:
the one or more valid gestures within the one or more images comprise a plurality of the same valid gesture from at least two of the one or more ride operators.

14. The method of claim 11, wherein processing the one or more valid gestures within the one or more images to enable a ride operation comprises:
enabling the ride operation when:
the one or more valid gestures within the one or more images comprise a plurality of the same valid gesture from at least two of one or more ride operators, and
each of the plurality of the same valid gesture is present within the one or more images for a threshold duration.

15. The method of claim 11, wherein processing the one or more valid gestures within the one or more images to enable a ride operation comprises:
enabling a ride operation when:
the one or more valid gestures within the one or more images comprise a plurality of the same valid gesture from at least two of one or more ride operators,
each of the plurality of the same valid gesture is present within the images for a threshold duration, and
a corresponding operation signal is received from an operator control console.

16. The method of claim 11, wherein processing the one or more valid gestures within the one or more images to enable a ride operation comprises:
enabling the ride operation when:
the one or more valid gestures within one or more images comprise a single valid gesture from at least one of the one or more ride operators.

17. The method of claim 11, wherein processing the one or more valid gestures within the one or more images to enable a ride operation comprises:
enabling the ride operation when:
the one or more valid gestures within the images comprise a single valid gesture from at least one of the one or more ride operators, and
the single valid gesture is present within the one or more images for a threshold duration.

18. A ride control processor comprising:
a machine-learned module configured to recognize one or more valid gestures within one or more images, where a valid gesture corresponds to a gesture from at least one of one or more ride operators within a ride station area, the machine-learned module comprising:
a first model trained to identify within images, a gesture corresponding to a gesture within a set of programmed gestures, and
a second model trained to determine the gesture is made by at least one of the one or more of ride operators; and
program logic configured to process the one or more valid gestures within the one or more images to enable a ride operation.

19. The ride control processor of claim 18, wherein the first model comprises a convolutional neural network trained to identify a gesture corresponding to a gesture within the set of programmed gestures based on a labeled dataset of images of programmed gestures captured at one or more locations within the ride station area.

20. The ride control processor of claim 18, wherein the second model comprises a convolutional neural network trained to determine the gesture is made by at least one of the one or more ride operators based on a labeled dataset of images of a feature associated with the one or more ride operators.
